(19) United States
(12) Patent Application Publication
(10) Pub. No.: US 2025/0008087 A1
(43) Pub. Date: Jan. 2, 2025

(54) PREDICTING CHROMA DATA USING CROSS-COMPONENT PREDICTION FOR VIDEO CODING

(71) Applicant: QUALCOMM Incorporated, San Diego, CA (US)

(72) Inventors: Han Huang, San Diego, CA (US); Vadim Seregin, San Diego, CA (US); Chun-Chi Chen, San Diego, CA (US); Marta Karczewicz, San Diego, CA (US)

(21) Appl. No.: 18/757,018

(22) Filed: Jun. 27, 2024

Related U.S. Application Data
(60) Provisional application No. 63/511,386, filed on Jun. 30, 2023.

(51) Int. Cl. H04N 19/105; H04N 19/117; H04N 19/176; H04N 19/186

(52) U.S. Cl. CPC H04N 19/105; H04N 19/117; H04N 19/176; H04N 19/186

(57) ABSTRACT

An example device includes a memory configured to store video data; and a processing system comprising one or more processors implemented in circuitry and configured to: construct a merge candidate list for a current block of video data, wherein the processing system is configured to add a first merge candidate that was predicted using a first convolutional cross component model (CCCM) to the merge candidate list and add a second merge candidate that was predicted using a second CCCM to the merge candidate list, the first CCCM being different than the second CCCM; decode a merge index value for the current block of video data, the merge index value indicating the first merge candidate; in response to the merge index value indicating the first merge candidate, form a prediction block for the current block using the first CCCM; and decode the current block using the prediction block.

This application claims the benefit of U.S. Provisional Application No. 63/511,836, filed Jun. 30, 2023, the entire contents of which are hereby incorporated by reference.

### TECHNICAL FIELD

This disclosure relates to video coding, including video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques related to prediction in video coding. In particular, video data may include luminance (luma) data and chrominance (chroma) data. Luma data generally represents brightness values for a block or other region of a picture of video data. Chroma data generally represents color values for a corresponding luma block. In some cases, chroma data may be coded using corresponding luma data. Per the techniques of this disclosure, a chrominance block may be predicted using a convolutional cross-component model (CCCM). Prediction information for the chrominance block may be coded using a merge candidate index. That is, a merge candidate list may be constructed, including merge candidates, e.g., spatial neighboring blocks to the chrominance block, which may be immediately adjacent to the chrominance block or separated by one or more other blocks. Per these techniques, the neighboring blocks may be predicted according to different models for CCCM, e.g., having different model parameters. Rather than explicitly coding the parameters in the bitstream, the model or model parameters may be inherited from the merge candidate for the current chrominance block. In this manner, the bitrate for the bitstream may be reduced, because the parameters for the model do not need to be explicitly signaled, but instead, may be inherited. Additionally or alternatively, the video coder may avoid the necessity of recalculating the parameters, which may improve processing efficiency and reduce processing cycles.

In one example, a method of decoding video data includes: constructing a merge candidate list for a current block of video data, including adding a first merge candidate that was predicted using a first convolutional cross component model (CCCM) to the merge candidate list and adding a second merge candidate that was predicted using a second CCCM to the merge candidate list, the first CCCM being different than the second CCCM; decoding a merge index value for the current block of video data, the merge index value indicating the first merge candidate; in response to the merge index value indicating the first merge candidate, forming a prediction block for the current block using the first CCCM; and decoding the current block using the prediction block.

In another example, a device for decoding video data includes: a memory configured to store video data; and a processing system comprising one or more processors implemented in circuitry, the processing system being configured to: construct a merge candidate list for a current block of video data, wherein the processing system is configured to add a first merge candidate that was predicted using a first convolutional cross component model (CCCM) to the merge candidate list and add a second merge candidate that was predicted using a second CCCM to the merge candidate list, the first CCCM being different than the second CCCM; decode a merge index value for the current block of video data, the merge index value indicating the first merge candidate; in response to the merge index value indicating the first merge candidate, form a prediction block for the current block using the first CCCM; and decode the current block using the prediction block.

In another example, a device for decoding video data includes: means for constructing a merge candidate list for a current block of video data, including means for adding a first merge candidate that was predicted using a first convolutional cross component model (CCCM) to the merge candidate list and means for adding a second merge candidate that was predicted using a second CCCM to the merge candidate list, the first CCCM being different than the second CCCM; means for decoding a merge index value for the current block of video data, the merge index value indicating the first merge candidate; means for forming a prediction block for the current block using the first CCCM in response to the merge index value indicating the first merge candidate; and means for decoding the current block using the prediction block.

In another example, a computer-readable storage medium has stored thereon instructions that, when executed, cause a processor to: construct a merge candidate list for a current block of video data, including instructions that cause the processor to add a first merge candidate that was predicted using a first convolutional cross component model (CCCM) to the merge candidate list and add a second merge candidate that was predicted using a second CCCM to the merge candidate list, the first CCCM being different than the second CCCM; decode a merge index value for the current block of video data, the merge index value indicating the first merge candidate; in response to the merge index value indicating the first merge candidate, form a prediction block for the current block using the first CCCM; and decode the current block using the prediction block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a conceptual diagram illustrating an example spatial portion of a convolutional filter.

FIG. 3 is a conceptual diagram illustrating an example reference area, with padding, used to derive filter coefficients.

FIG. 4 is a conceptual diagram illustrating an example set of spatial samples used for gradient and location-based convolutional cross-component model (CCCM).

FIG. 5 is a conceptual diagram illustrating luminance (luma) samples L0-L5 in relation to a chroma sample C.

FIG. 6 is a conceptual diagram illustrating five locations in reconstructed luma samples.

FIG. 7 is a conceptual diagram illustrating an example reference area for block vector guided CCCM (BVG-CCCM).

FIG. 8 is a conceptual diagram illustrating use of both a neighboring reference area and a reference area located using a block vector for enhanced block vector guided CCCM according to techniques of this disclosure.

FIGS. 9A and 9B are conceptual diagrams illustrating locations of luma samples corresponding to a chrominance sample in 4:2:2 color format (FIG. 9A) and in 4:4:4 color format (FIG. 9B).

FIG. 10 is a block diagram illustrating an example video encoder that may perform the techniques of this disclosure.

FIG. 11 is a block diagram illustrating an example video decoder that may perform the techniques of this disclosure.

FIG. 12 is a flowchart illustrating an example method for encoding a current block in accordance with the techniques of this disclosure.

FIG. 13 is a flowchart illustrating an example method for decoding a current block in accordance with the techniques of this disclosure.

FIG. 14 is a flowchart illustrating an example method of decoding video data according to techniques of this disclosure.

### DETAILED DESCRIPTION

Video coding generally includes predicting blocks of video data and coding residual data representing differences between the prediction blocks and originally captured or generated blocks of video data. Originally captured video data may be captured in a red-green-blue format, then transformed to a luminance (luma) and chrominance (chroma) format, e.g., including luma blocks, blue hue chroma blocks, and red hue chroma blocks. Prediction information for the luma blocks may generally be reused when coding collocated chroma blocks.

The techniques of this disclosure generally relate to the use of convolutional cross-component model (CCCM) prediction for chroma blocks. That is, a vector may be coded for a current chroma block, which identifies a reference chroma block in the same picture. Pixels of the current chroma block may be predicted using the reference chroma block and/or using a reference luma block collocated with the reference chroma block. Additionally, samples of the collocated chroma block may also be used to predict the current chroma block (e.g., to filter an initially formed prediction block). There are various different types of CCCM-based prediction techniques, as explained in greater detail below. Thus, different blocks may be predicted with different CCCM techniques, and therefore, different CCCM models. Each different model may have different respective parameters.

Prediction information for a current chroma block may be coded using merge mode coding. In general, merge mode involves constructing a merge candidate list, which includes prediction information for neighboring blocks to the current block. These neighboring blocks may be spatially adjacent to the current block or separated by one or more blocks from the current block (e.g., to the left and/or above the current block when blocks are coded in raster scan order from left to right and top to bottom). The neighboring blocks may be coded using a CCCM-based prediction technique, and thus, each have distinct parameters for models of the corresponding CCCM-based prediction technique. Per the techniques of this disclosure, a current chroma block may inherit the model and parameters of a merge candidate of the merge candidate list as identified by a merge index. In this manner, coding of the parameters of the model can be avoided, which may reduce the overall bitrate of a bitstream including the coded video data.

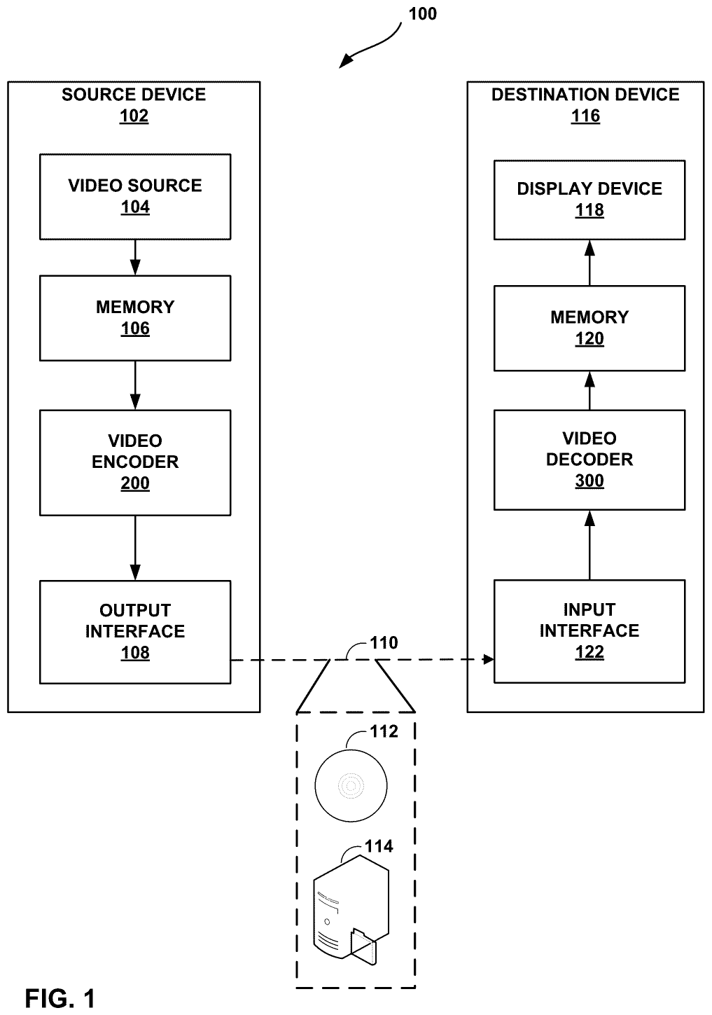

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques including predicting chroma data using cross-component prediction. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for predicting chroma data using cross-component prediction. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that predict chroma data using cross-component prediction.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component may be an array or single sample from one of the three arrays (luma and two chroma) for a picture in 4:2:0, 4:2:2, or 4:4:4 color format, or an array or a single sample of the array for a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients.

Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

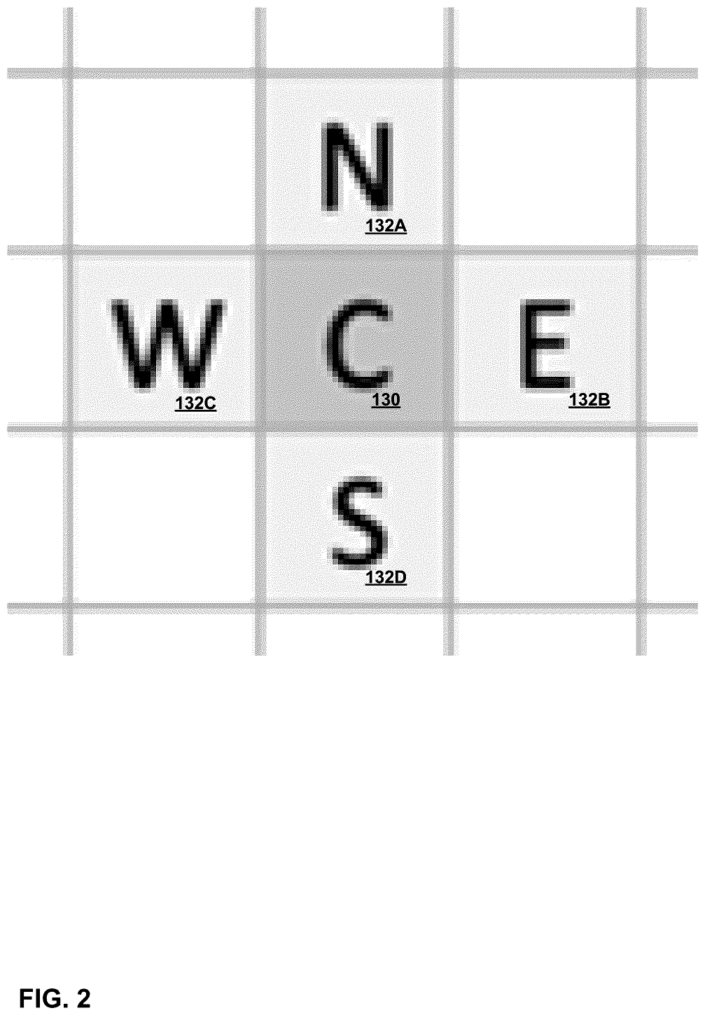

FIG. 2 is a conceptual diagram illustrating an example spatial portion of a convolutional filter. In some examples, video coders such as video encoder 200 and video decoder 300 are configured to apply a convolutional cross-component model (CCCM) to predict chrominance (chroma) samples using reconstructed luminance (luma) samples, as in cross-component linear model (CCLM) modes. Video encoder 200 and video decoder 300 may apply the CCCM model after decoding/reconstructing video data. As with CCLM, in CCCM, the reconstructed luma samples may be downsampled to match the lower resolution of the chroma data when chroma sub-sampling is used.

Similar to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

In CCCM, a 7-tap filter includes a 5-tap plus sign shaped spatial component (as shown in FIG. 2), a nonlinear term P, and a bias term B. The input to the spatial 5-tap component of the filter includes a center (C) luma sample 130, which is collocated with the chroma sample to be predicted and its above/north (N) neighbor 132A, below/south(S) neighbor 132B, left/west (W) neighbor 132C, and right/east (E) neighbor 132D as illustrated in FIG. 2.

If the color format of the video data is not 4:4:4, i.e., chroma has a lower number of samples than luma, the luma samples described above may be down sampled luma samples. The nonlinear term P may be represented as power of two of the center luma sample C and scaled to the sample value range of the content, as follows

$$P = ( C * C + midVal ) >> bitDepth$$

For example, for 10-bit content, P may be calculated as:

$$P = ( C * C + 5 \; 12 ) >> 10$$

The bias term B represents a scalar offset between the input and output (similarly to the offset term in CCLM) and is set to middle chroma value (512 for 10-bit content).

Output of the filter may be calculated as a convolution between the filter coefficients cᵢ and the input values and clipped to the range of valid chroma samples, as follows:

$$predChromaVal = {c}_{0} C + {c}_{1} N + {c}_{2} S + {c}_{3} E + {c}_{4} W + {c}_{5} P + {c}_{6} B$$

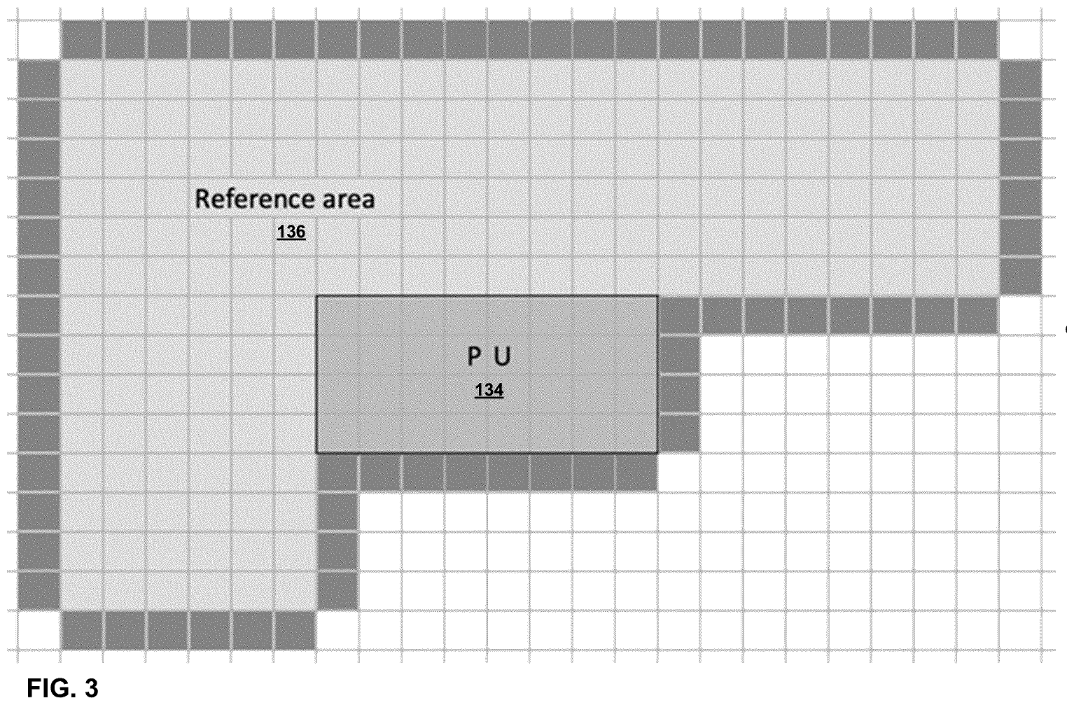

FIG. 3 is a conceptual diagram illustrating an example reference area, with padding, used to derive filter coefficients. As discussed above, a filter may include filter coefficients cᵢ. The filter coefficients cᵢ may be calculated by minimising a mean squared error (MSE) between predicted and reconstructed chroma samples in the reference area. FIG. 3 illustrates reference area 136, which in this example, includes 6 lines of chroma samples above and left of PU 134. The reference area extends one PU width to the right and one PU height below the PU boundaries. The area may be adjusted to include only available samples. The extensions to the area shown in blue are needed to support the “side samples” of the plus shaped spatial filter and are padded when in unavailable areas.

The MSE minimization may be performed by calculating autocorrelation matrix for the luma input and a cross-correlation vector between the luma input and chroma output. The autocorrelation matrix may be LDL decomposed, and the final filter coefficients may be calculated using back-substitution. The process follows roughly the calculation of the ALF filter coefficients in ECM. However, LDL decomposition may be used instead of Cholesky decomposition to avoid using square root operations. The approach of LDL composition uses only integer arithmetic.

In some examples, CCCM uses non-downsampled luma samples and no luma subsampling for CCCM to predict chroma samples from the reconstructed luma samples, i.e., without downsampling. In the case of typical 4:2:0 color format, this example of CCM uses a filter including 6-tap spatial terms, four nonlinear terms, and a bias term. The 6-tap spatial terms correspond to 6 neighboring luma samples (i.e., L₀, L₁, . . . , L₅) around the chroma sample (i.e., C) to be predicted, the four non-linear terms are derived from the samples L₀, L₁, L₂, and L₃. The following example formula may be used to calculate a value for C:

$$C = {\sum }_{i = 0}^{5} {α}_{i} \cdot ( {L}_{i} - offsetLuma ) + {\sum }_{i = 6}^{9} {α}_{i} \cdot ( ( {( {L}_{i - 4} - offsetLuma )}^{2} + β ) >> bitDepth ) + {α}_{10} \cdot β + offsetChroma$$

In this example, αᵢ is the coefficient, β is the offset. If the coordinate of chroma sample is (x, y), the coordinate for Lᵢ (i=0, 1, . . . , 5) are (2x−1, 2y), (2x, 2y), (2x+1, 2y), (2x−1, 2y+1), (2x, 2y+1), (2x+1, 2y+1), respectively.

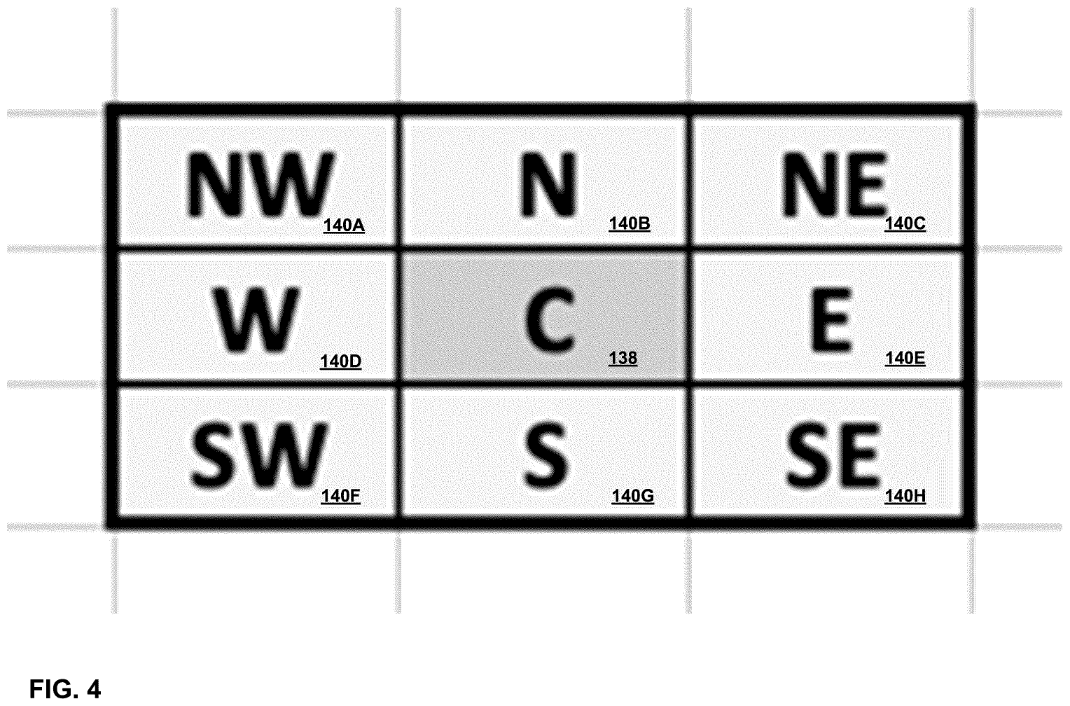

FIG. 4 is a conceptual diagram illustrating an example set of spatial samples used for gradient and location-based convolutional cross-component model (GL-CCCM). In particular for center sample 138, neighboring samples NW 140A, N 140B, NE 140C, W 140D, E 140E, SW 140F, S 140G, SE 140H GL-CCCM uses gradient and location information, instead of the 4 spatial neighbor samples in the CCCM filter as discussed above. An example GL-CCCM filter for prediction is:

$$predChromaVal = {c}_{0} C + {c}_{1} {G}_{y} + {c}_{2} {G}_{x} + {c}_{3} Y + {c}_{4} X + {c}_{5} P + {c}_{6} B$$

In this example, G_{y} and Gₓ are the vertical and horizontal gradients, respectively, and may be calculated as:

$${G}_{y} = ( 2 N + NW + NE ) - ( 2 S + SW + SE )$$

$${G}_{x} = ( 2 W + NW + SW ) - ( 2 E + NE + SE )$$

Moreover, the Y and X parameters are the vertical and horizontal locations of the center luma sample. The rest of the parameters may be the same as CCCM tool. The reference area for the parameter calculation may be the same as CCCM method.

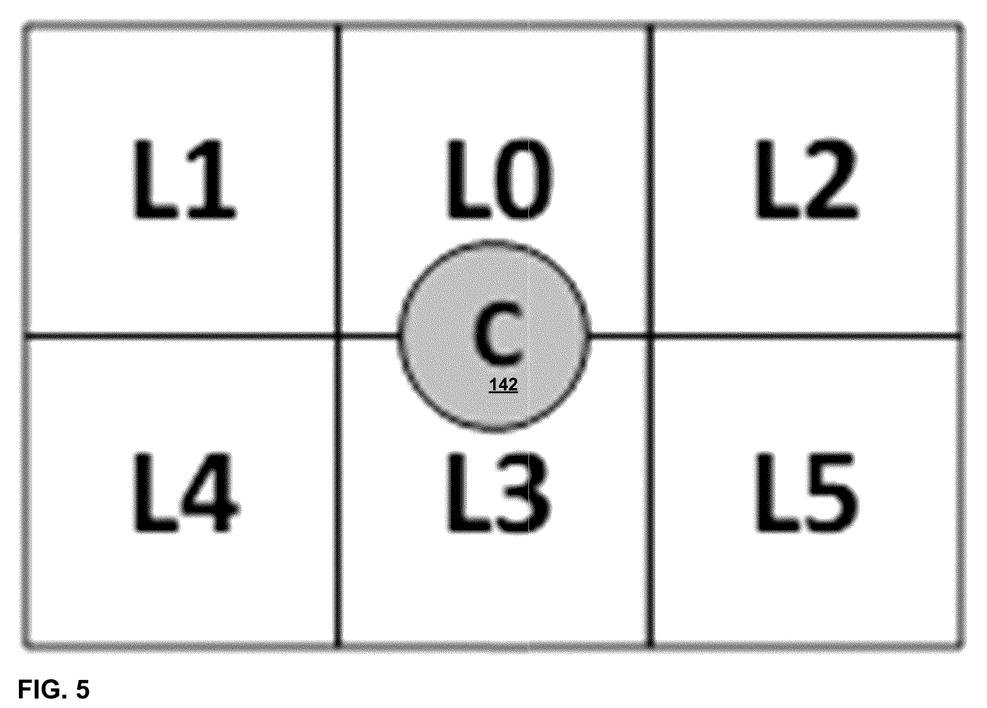

FIG. 5 is a conceptual diagram illustrating luminance (luma) samples L0-L5 in relation to a chroma sample C 142. In some examples, cross-component residual model (CCRM) is applied to predict chroma samples from reconstructed luma samples when the block uses inter prediction or intra block copy (IBC). The cross-component filters may be derived using the prediction signals of luma and chroma. The derived filters may be applied to the reconstructed luma signal producing the final chroma predictions.

In some examples, an 8-tap filter for CCRM includes 6 spatial luma samples, a nonlinear term, and a bias term. The spatial luma samples (L0, . . . , L5) may be obtained from the luma grid, selecting the 6 luma samples closest to the chroma position C without down sampling, as shown in FIG. 5. The predicted chroma value may be calculated according to:

$$predChromaVal = {c}_{0} L 0 + {c}_{1} L 1 + {c}_{2} L 2 + {c}_{3} L 3 + {c}_{4} L 4 + {c}_{5} L 5 + {c}_{6}$$

$$nonlinear ( ( L 0 + L 3 + 1 ) >> 1 ) + {c}_{7} B ,$$

where nonlinear is CCCM's nonlinear operator and B is bias.

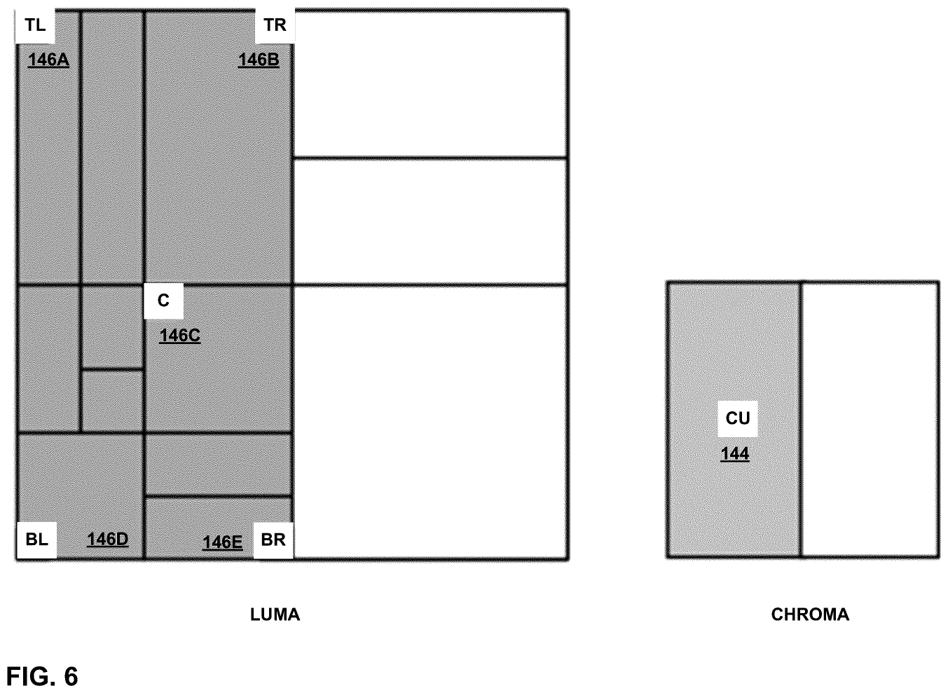

FIG. 6 is a conceptual diagram illustrating five sample locations in reconstructed luma samples. In some examples, a direct block vector may be used to improve the coding efficiency for chroma components when dual tree is activated in intra slice. This method specifically includes two implementations. When chroma dual tree is activated in intra slice, for a chroma CU 144 coded as DBV mode, if one of the luma blocks in five locations including top left (TL) 146A, top right (TR) 146B, center (C) 146C, bottom left (BL) 146D, and bottom right (BR) 146E, as shown in FIG. 5, these five locations of reconstructed luma samples may be coded with IBC mode or IntraTmp mode, and its block vector bvL may be used to derive chroma block vector bvC.

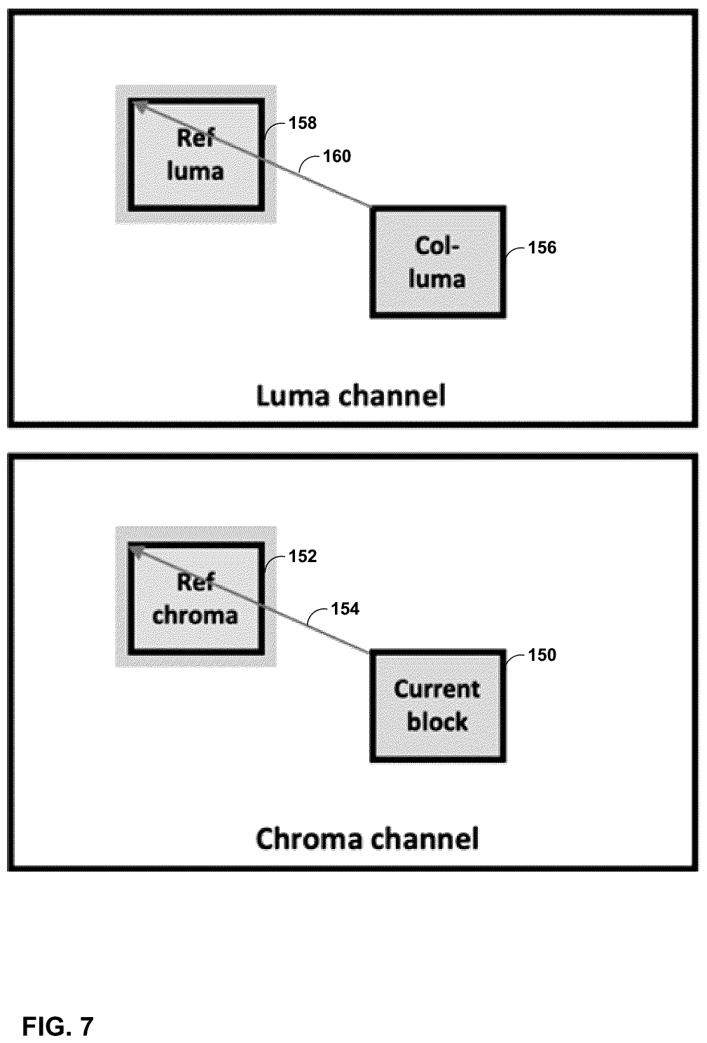

FIG. 7 is a conceptual diagram illustrating an example reference area for block vector guided CCCM (BVG-CCCM). In some examples, a block vector guided CCCM (BVG-CCCM) technique may be used to improve the coding efficiency of ECM. The BVG-CCCM technique uses block vector 160 of co-located luma block 156, coded in IBC or intraTMP mode, to determine the reference area corresponding to reference luma block 158 for calculating the CCCM parameters. That is, block vector 154 that is coded for current block 150 indicates the location of reference chroma block 152. Current block 150 corresponds to co-located luma block 156. The same offset of block vector 154 may be applied to the position of co-located luma block 156 (as block vector 160) to determine the location of reference luma block 158. Then the reference area in the luma channel, and a corresponding area in the chroma channel, may be used to calculate the CCCM parameters. The prediction may use the calculated model parameters and co-located luma samples to do the CCCM prediction. FIG. 7 illustrates an example reference area for BVC-CCCM.

Similar to Direct Block Vector (DBV) mode in ECM-8.0, five locations in collocated luma block area may be scanned to determine the block vector to be used in BVG-CCCM. Usage of the mode may be signalled with a CABAC coded PU level flag. The BVG-CCCM flag may be signalled if a co-located block is coded in IBC or intraTMP modes and the cross-component index is LM_CHROMA_IDX or MMLM_CHROMA_IDX.

In some examples, a cross-component merge (CCMerge) mode for chroma intra coding is introduced, comprising cross-component model parameters inheritance for the current chroma block from its spatial adjacent and non-adjacent neighbors, or default models. The spatial adjacent and non-adjacent neighboring information may be collected from the previously coded blocks by CCLM, MMLM, CCCM, GLM, chroma fusion, and/or CCMerge modes. The final cross-component model parameters of the current chroma block can be inherited from its spatial adjacent and non-adjacent neighbors, or default models. A list may be created, which includes CCP models from the spatial adjacent and non-adjacent neighbors coded in CCLM, MMLM, CCCM, GLM, chroma fusion, and CCMerge modes. After including neighboring CCP models, default models are further included to fill the remaining empty positions in the list. To avoid including redundant CCP models in the list, pruning operations may be applied.

In some examples, implementation of CCCM may be simplified by removing the mean of reference samples from the sample values and replacing the division operation by a piece-wise polynomial function. Removal of the division operation introduces an additional pipeline stage. In some examples, mean removal may instead be replaced by offset removal, which does not add any additional pipeline stage nor additional sample level operations. Fixed offsets may be from luma and chroma samples in each PU for each model. This may drive down the magnitudes of the values used in the model creation and allow reduction of the precision needed for the fixed-point arithmetic. As a result, 16-bit decimal precision may be used instead of the 22-bit precision of the original CCCM implementation.

Reference sample values just outside of the top-left corner of the PU may be used as the offsets (offsetLuma, offsetCb and offsetCr) for simplicity. The sample values used in both model creation and final prediction (i.e., luma and chroma in the reference area, and luma in the current PU) may be reduced by these fixed values, as follows:

$${C}^{′} = C - offsetLuma$$

$${N}^{′} = N - offsetLuma$$

$${S}^{′} = S - offsetLuma$$

$${E}^{′} = E - offsetLuma$$

$${W}^{′} = W - offsetLuma$$

$${P}^{′} = nonLinear ( {C}^{′} )$$

$$B = midValue = 1 << ( bitDepth - 1 )$$

The chroma value may be predicted using the following equation, where offsetChroma is equal to offsetCr and offsetCb for Cr and Cb components, respectively:

$$predChromaVal = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} {B}^{′} + offsetChroma$$

In order to avoid any additional sample level operations, the luma offset may be removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model. With this selection the convolution operation also takes exactly the same amount of operations as the original implementation of CCCM.

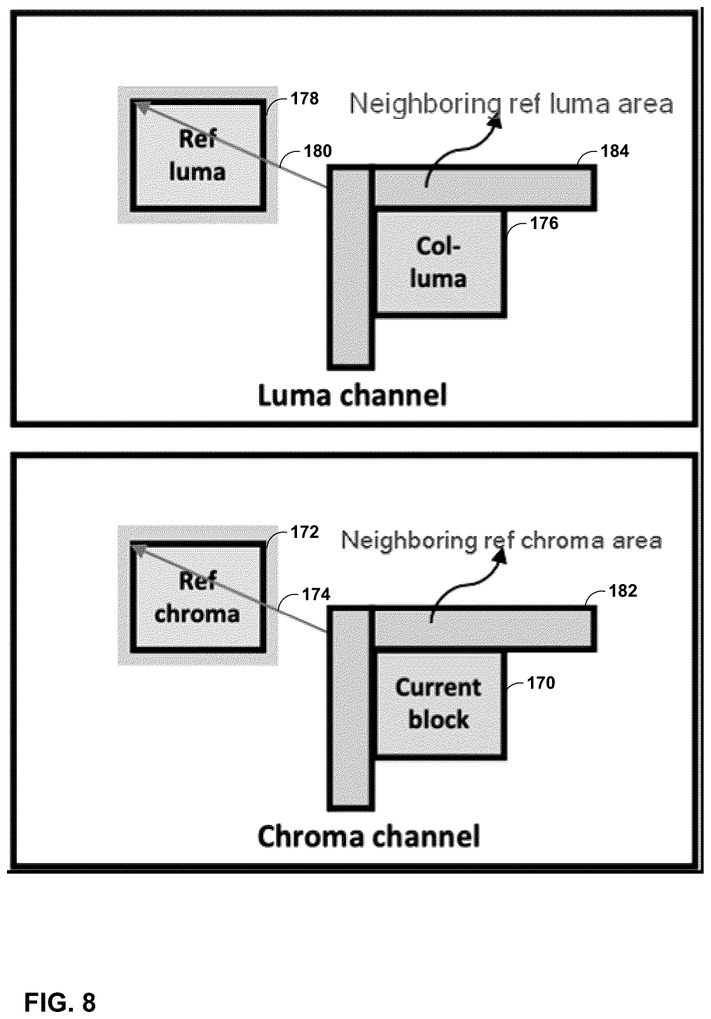

FIG. 8 is a conceptual diagram illustrating use of both a neighboring reference area and a reference area located using a block vector for enhanced block vector guided CCCM according to techniques of this disclosure. Per the techniques of this disclosure, video encoder 200 and video decoder 300 may be configured to perform enhanced block vector guided CCCM. For example, values of neighboring reference areas to the current chroma block and the collocated luma block may be used, in conjunction with reference areas located by the block vector, to calculate filter coefficients for CCCM, as shown in FIG. 8. In particular, block vector 174 may be coded for current block 170, which refers to reference chroma block 172. Current block 170 corresponds to co-located block 176, and block vector 180 (when applied to the position of co-located luma block 176) indicates the location of reference luma block 176. In addition to reference chroma block 172 and reference luma block 178, neighboring reference chroma area 182 and neighboring reference luma area 184 may be used to form a prediction block for current block 170. This general technique may be referred to as EBVG-CCCM in the following description.

In some examples, EBVG-CCCM may be used as a replacement for BVG-CCCM. In some examples, EBVG-CCCM may be used as an additional mode to that of BVG-CCCM, and video encoder 200 and video decoder 300 may be configured to code values for one or more syntax elements to indicate whether EBVG-CCCM or BVG-CCCM, or a different CCCM mode, is to be used for a current block. Alternatively, the CCCM mode may be inferred from one or more other coded values.

In some examples, the chroma predictors generated by BVG-CCCM and DBV mode may be fused (using weighted averaging) to generate a final predictor. EBVG-CCCM may be used to replace BVG-CCCM or as an additional mode to fuse with DBV. In some examples, the fusion is always applied when BVG-CCCM/EBVG-CCCM mode is used. In some examples, the fusion is controlled by a flag as a new mode for chroma prediction.

In some examples, the parameters of BVG-CCCM may be stored for use as candidates for cross-component merge mode. Therefore, in CCMerge mode, the spatial adjacent and non-adjacent neighboring information may also be collected from BVG-CCCM mode or its variants (for example, fusion of BVG-CCCM and DBV).

In some examples, the parameters of cross-component residual model (CCRM) may be stored for use as candidates for cross-component merge mode. Therefore, in CCMerge mode, the spatial adjacent and non-adjacent neighboring information may also be collected from CCRM mode or its variants.

The CCRM and BVG-CCCM modes both use non-downsampled luma samples. However, the cross-component prediction models are slightly different. In CCCM using non-downsampled luma samples, 4 non-linear terms are used, whereas in CCRM mode, one linear term is used (with averaged luma value from two samples), and in BVG-CCCM 5 non-linear terms are used. In some examples, per the techniques of this disclosure, the same model may be used for each of these modes. It can be any one of the models, but one model may be used for all of these modes.

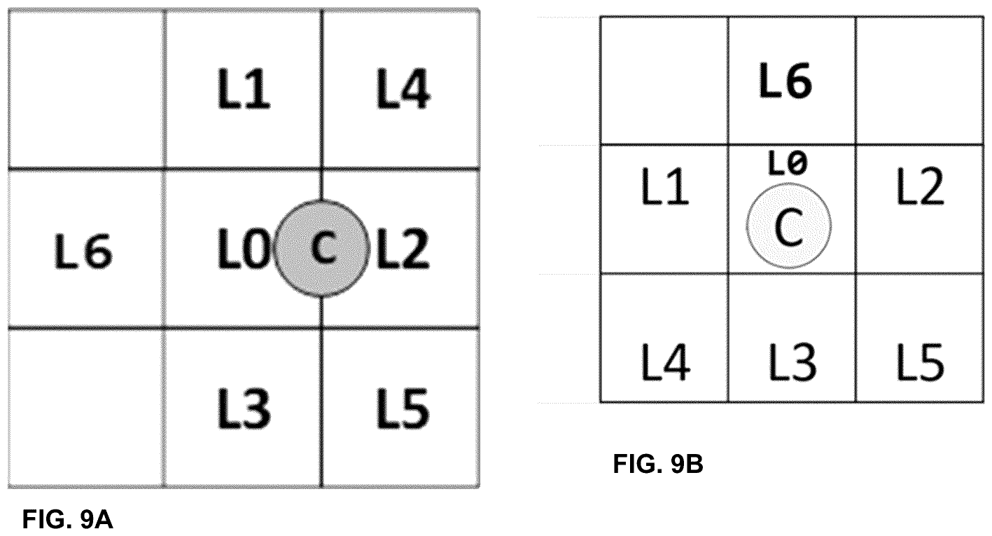

FIGS. 9A and 9B are conceptual diagrams illustrating locations of luma samples corresponding to a chrominance sample in 4:2:2 color format (FIG. 9A) and in 4:4:4 color format (FIG. 9B). In some examples, different models (filters) may be used for cross-component prediction, depending on color format.

In some examples, in CCRM, the average value of L0 and L3 (that is (L0+L3+1)>>1) is used to derive the nonlinear term in 4:2:0 color format, the average value of L0 and L2 (that is (L0+L2+1)>>1) may be used in the 4:2:2 color format, and the average value of L0, L1, L2 and L3 (that is (L0+L1+L2+L3+2)>>2) may be used in the 4:4:4 color format.

In some examples, a weighted average may be applied for non-4:2:0 color formats. In CCRM, the weighted average value of L0, L2, and L6 (that is (2*L0+L2+L6+2)>>2) may be used in the 4:2:2 color format, and the weighted average value of L0, L1, L2, L3, L5 and L6 (that is (5*L0+L1+L2+L3+4)>>3 or (4*L0+L1+L2+L3+L6+4)>>3) may be used in the 4:4:4 color format.

In some examples, in 4:2:0 color format, the luma samples at coordinates (2x, 2y), (2x−1, 2y), (2x+1, 2y), (2x, 2y+1), (2x−1, 2y+1), and (2x+1, 2y+1) are used as reference luma samples for a chroma sample at coordinate (x,y), as shown in FIG. 5, but the luma samples at coordinate (2x, 2y), (2x, 2y−1), (2x+1, 2y), (2x, 2y+1), (2x+1, 2y−1), (2x+1, 2y+1) may be used as reference luma samples, as illustrated in FIGS. 9A and 9B.

In prediction models, such as cross-component prediction, a bias term may be used, which is added with some weighting value to the model. In one example, the model with bias term is shown in FIG. 2, where the bias is represented as “B”. In these examples, the bias term may be fixed and set equal to the mid value (between min and max) of the sample range. However, as a fixed value, the bias value may not represent a current block content and thus may be less efficient in the model.

Thus, the techniques of this disclosure may include adding a content dependent bias term in the model. This new bias term may replace the existed fixed one, or may be additionally added to the model, e.g., added with a weight value. The weight value may be derived based on the already reconstructed values, such as luma and/or chroma values. In another alternative, the new bias term may be added as a weighted sum or linear combination to the existing bias. For example, the final bias may be represented as c1*B1+c2*B2, where B1 is the existing bias, B2 is the content adaptive bias, and c1 and c2 may be predefined coefficients. In one example, final bias may be represented as B1-B2.

The content dependent bias may be added using luma and/or chroma component, or using just one luma component. There may be multiple ways to assign a content dependent bias, but one of the distinct characteristics is that the bias may be different for each block or a group of blocks.

In one example, the content dependent bias may be derived as a reconstructed luma value of a neighboring block, for example a top left neighbor sample. In another example, the content dependent bias may be derived as a reconstructed value of the current block, for example, a top left corner sample of the current or corresponding to the current, if dual tree partitioning is enabled (when luma and chroma may have different partitioning structure) block luma area.

In another example, the content dependent bias may be an average value across some neighboring reconstructed samples or, in another alternative, an average value derived from some samples of the current block, or as a combination of both.

In yet another example, the content dependent bias may be equal to the luma offset subtracted for the division free operation described in section 2.6.

In another example, the luma offset for dynamic range reduction may be subtracted from the bias, fixed or content dependent.

Similarly, a chroma bias (value derived from the chroma component) may be added to the model. This bias may be content dependent as well, and any earlier described technique above for luma content dependent bias may be used to derive the chroma bias.

In yet another example, the luma and chroma biases may be derived from the motion compensation predicted signal in case of CCRM. They may be derived by picking some representative sample (at top left or center of the block) or average value of all the samples.

In one example, if the content dependent luma bias B2 is added to the model, the model may be represented as follows:

$$predChromaVal = {c}_{0} C + {c}_{1} {G}_{y} + {c}_{2} {G}_{x} + {c}_{3} Y + {c}_{4} X + {c}_{5} P + {c}_{6} B 1 + {c}_{7} B 2 ,$$

where B1 is the existed fixed bias and B2 is the content dependent bias, cᵢ are the model parameters or weights.

When a new bias is added to the model, in cases the model is borrowed from the neighboring block and is applied to the current block. In one example, such model is a candidate in CCP merge method, the content dependent bias may be stored with the model since the model parameters are derived for the neighbor block bias, which may be different from the current block bias, and the stored bias may be used to derive the prediction for current block using the stored model.

In another alternative example, the bias of the current block may be used in the model, in such case the borrowed model bias it not needed to be stored.

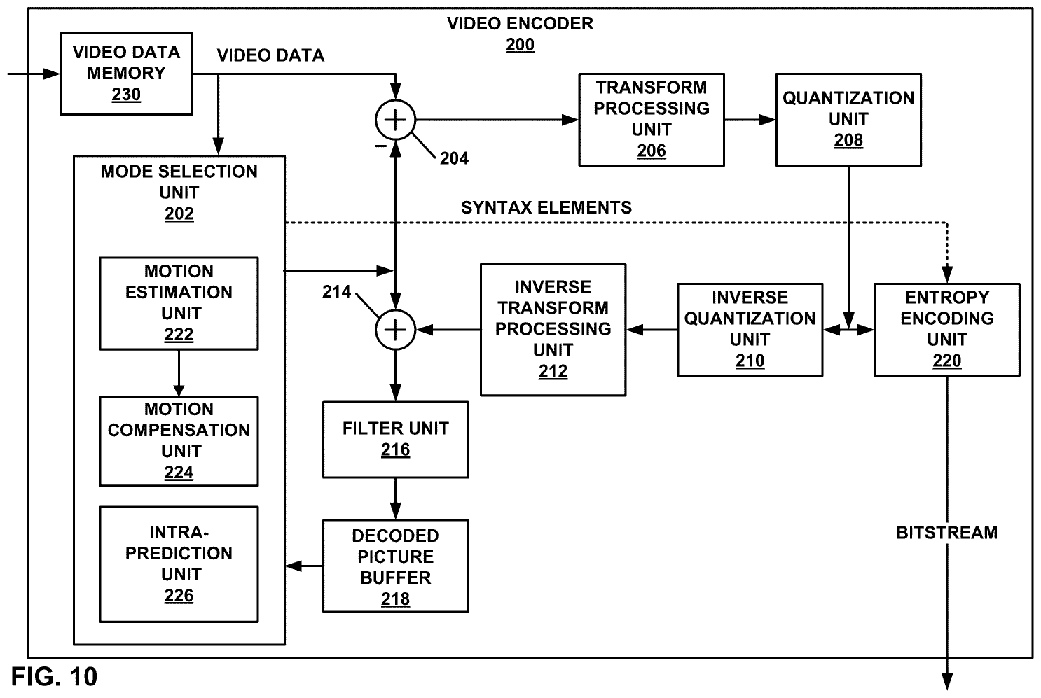

FIG. 10 is a block diagram illustrating an example video encoder 200 that may perform the techniques of this disclosure. FIG. 10 is provided for purposes of explanation and should not be considered limiting of the techniques as broadly exemplified and described in this disclosure. For purposes of explanation, this disclosure describes video encoder 200 according to the techniques of VVC (ITU-T H.266, under development) and HEVC (ITU-T H.265). However, the techniques of this disclosure may be performed by video encoding devices that are configured to other video coding standards and video coding formats, such as AV1 and successors to the AV1 video coding format.

In the example of FIG. 10, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 10 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quadtree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Furthermore, per the techniques of this disclosure, intra-prediction unit 226 and/or motion compensation unit 224 may be configured to predict a current block using a convolutional cross component model (CCCM) mode, as discussed in this disclosure.

When operating according to the AV1 video coding format, intra prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. Video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples. Filter unit 216 may be configured to perform any of the various techniques of this disclosure, e.g., as discussed above with respect to FIGS. 8 and 9.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 22 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

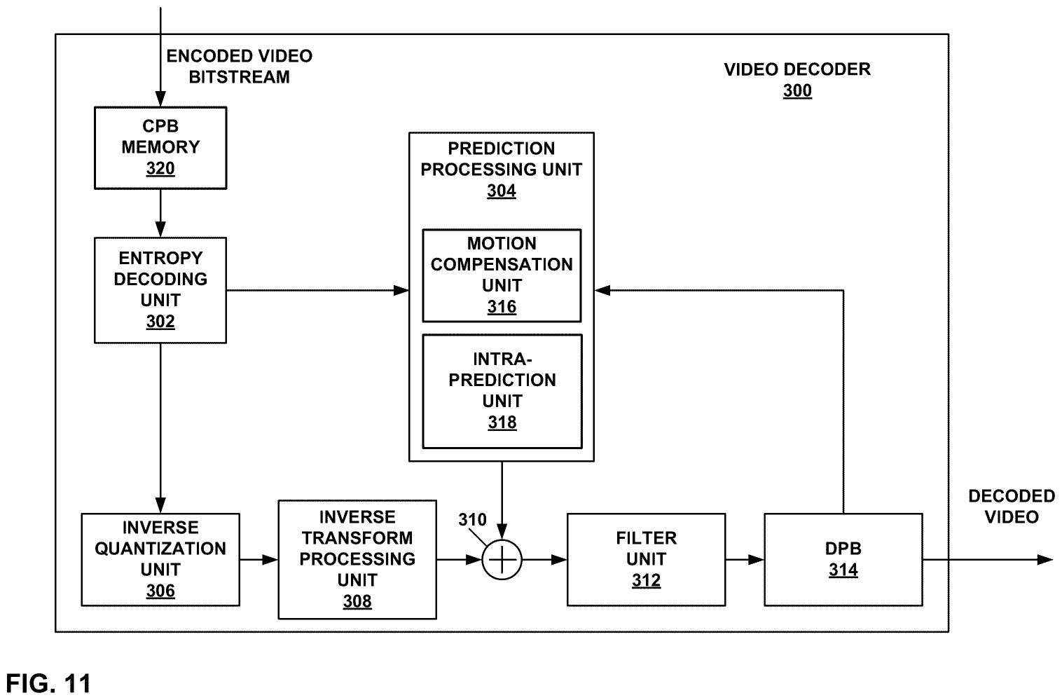

FIG. 11 is a block diagram illustrating an example video decoder 300 that may perform the techniques of this disclosure. FIG. 11 is provided for purposes of explanation and is not limiting on the techniques as broadly exemplified and described in this disclosure. For purposes of explanation, this disclosure describes video decoder 300 according to the techniques of VVC (ITU-T H.266, under development) and HEVC (ITU-T H.265). However, the techniques of this disclosure may be performed by video coding devices that are configured to other video coding standards.

In the example of FIG. 11, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

Furthermore, per the techniques of this disclosure, intra-prediction unit 318 and/or motion compensation unit 316 may be configured to predict a current block using a convolutional cross component model (CCCM) mode, as discussed in this disclosure.

When operating according to AV1, compensation unit 316 may be configured to decode coding blocks of video data (e.g., both luma and chroma coding blocks) using translational motion compensation, affine motion compensation, OBMC, and/or compound inter-intra prediction, as described above. Intra prediction unit 318 may be configured to decode coding blocks of video data (e.g., both luma and chroma coding blocks) using directional intra prediction, non-directional intra prediction, recursive filter intra prediction, CFL, intra block copy (IBC), and/or color palette mode, as described above.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 11 are illustrated to assist with understanding the operations performed by video decoder 300. The units may be implemented as fixed-function circuits, programmable circuits, or a combination thereof. Similar to FIG. 10, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 10).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 10). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples. Filter unit 312 may be configured to perform any of the various techniques of this disclosure, e.g., as discussed above with respect to FIGS. 8 and 9.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

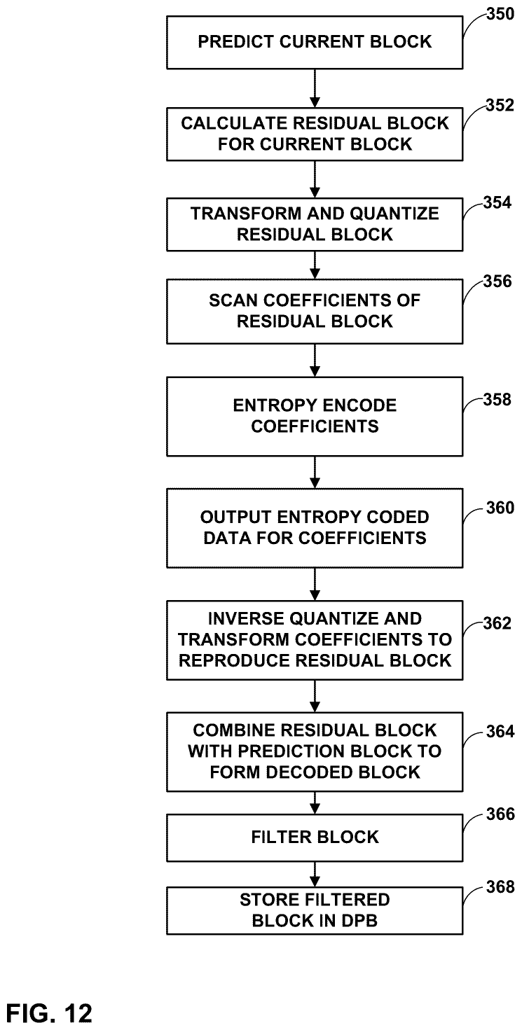

FIG. 12 is a flowchart illustrating an example method for encoding a current block in accordance with the techniques of this disclosure. The current block may comprise a current CU. Although described with respect to video encoder 200 (FIGS. 1 and 10), it should be understood that other devices may be configured to perform a method similar to that of FIG. 12.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, uncoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

Video encoder 200 may also decode the current block after encoding the current block, to use the decoded version of the current block as reference data for subsequently coded data (e.g., in inter- or intra-prediction modes). Thus, video encoder 200 may inverse quantize and inverse transform the coefficients to reproduce the residual block (362). Video encoder 200 may combine the residual block with the prediction block to form a decoded block (364). Video encoder 200 may then filter the block according to any of the various techniques of this disclosure (366). Video encoder 200 may then store the filtered block in DPB 218 (368).

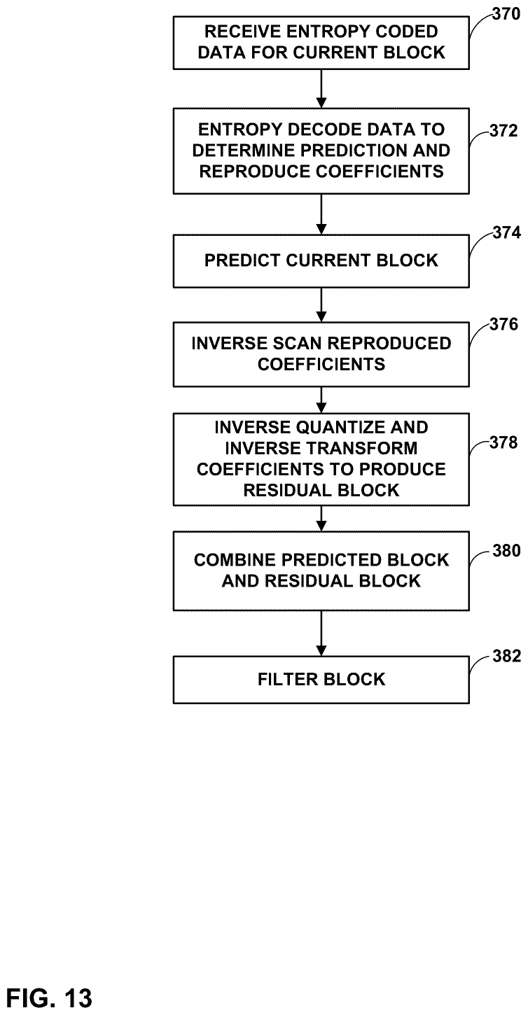

FIG. 13 is a flowchart illustrating an example method for decoding a current block of video data in accordance with the techniques of this disclosure. The current block may comprise a current CU. Although described with respect to video decoder 300 (FIGS. 1 and 11), it should be understood that other devices may be configured to perform a method similar to that of FIG. 13.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380). Moreover, video decoder 300 may filter the decoded block according to any of the various techniques of this disclosure (382).

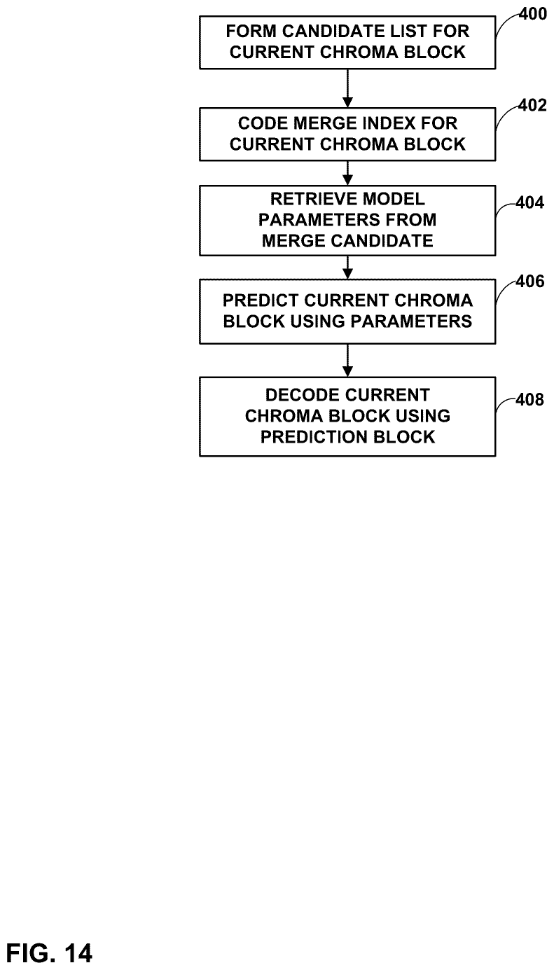

FIG. 14 is a flowchart illustrating an example method of decoding video data according to techniques of this disclosure. The method of FIG. 14 is explained with respect to video decoder 300 of FIGS. 1 and 11. However, other video coding devices may be configured to perform this or a similar method. For example, video encoder 200 of FIGS. 1 and 10 may be configured to decode video data using similar techniques during a decoding loop.

Initially, video decoder 300 forms a merge candidate list for a current chrominance (chroma) block (400). The merge candidate list includes spatial neighboring candidates to the current chroma block. Thus, creation of the candidate list may include adding candidates having different convolutional cross component model (CCCM) models and parameters, e.g., a first candidate having a first CCCM model (and first set of parameters) and a second candidate having a second, different CCCM model (and second, different set of parameters). When video decoder 300 decodes the first and second candidates, video decoder 300 may store the respective parameters used to predict the first and second candidates for subsequent access, as discussed below.

Video decoder 300 may then decode a merge candidate index for the current chroma block (402). The merge candidate index identifies one of the candidates in the merge candidate list. Accordingly, video decoder 300 may retrieve the model parameters from the merge candidate indicated by the merge candidate index (404).

Video decoder 300 may then predict the current chroma block using the retrieved parameters (406) to form a prediction block. Video decoder 300 may predict the current chroma block using the CCCM mode of the merge candidate, e.g., one of cross-component linear model (CCLM), single model CCCM, multi-model CCCM, gradient and location based CCCM (GL-CCCM), block vector guided CCCM (BVG-CCCM), enhanced BVG-CCCM (EBVG-CCCM), or any other such CCCM mode.

Video decoder 300 may then decode the current chroma block using the prediction block (408). For example, video decoder 300 may decode a residual block and combine the residual block with the prediction block on a pixel-by-pixel basis to reconstruct the original block.

In this manner, the method of FIG. 14 represents an example of a method of decoding video data, including constructing a merge candidate list for a current block of video data, including adding a first merge candidate that was predicted using a first convolutional cross component model (CCCM) to the merge candidate list and adding a second merge candidate that was predicted using a second CCCM to the merge candidate list, the first CCCM being different than the second CCCM; decoding a merge index value for the current block of video data, the merge index value indicating the first merge candidate; in response to the merge index value indicating the first merge candidate, forming a prediction block for the current block using the first CCCM; and decoding the current block using the prediction block.

Various techniques of this disclosure are summarized in the following clauses:

Clause 1: A method of filtering decoded video data, the method comprising: determining, for a current block of chrominance (chroma) data, a block vector referring to a reference block, a neighboring reference chroma data to the current block, and a neighboring reference luminance (luma) data to a collocated luma block; calculating filter coefficients to be used to filter the current block from the reference block, the neighboring reference chroma data, and the neighboring reference luma data; and filtering one or more samples of the current block using the filter coefficients.

Clause 2: The method of clause 1, wherein the block vector comprises a chroma block vector referring to a reference chroma block, the method further comprising determining a luma block vector referring to a reference luma block, wherein calculating the filter coefficients comprises calculating the filter coefficients using the reference luma block.

Clause 3: The method of any of clauses 1 and 2, wherein determining the block vector according to direct block vector (DVB) mode.

Clause 4: The method of any of clauses 1-3, further comprising encoding the current block prior to decoding the current block.

Clause 5: A device for decoding video data, the device comprising one or more means for performing the method of any of clauses 1-4.

Clause 6: The device of clause 5, wherein the one or more means comprise a processing system including one or more processors implemented in circuitry.

Clause 7: The device of any of clauses 5-6, further comprising a display configured to display the decoded video data.

Clause 8: The device of any of clauses 5-7, wherein the device comprises one or more of a camera, a computer, a mobile device, a broadcast receiver device, or a set-top box.

Clause 9: The device of clause 5-8, further comprising a memory configured to store the video data.

Clause 10: A computer-readable storage medium having stored thereon instructions that, when executed, cause a processor of a device for decoding video data to perform the method of any of clauses 1-4.

Clause 11: A device for decoding video data, the device comprising: means for determining, for a current block of chrominance (chroma) data, a block vector referring to a reference block, a neighboring reference chroma data to the current block, and a neighboring reference luminance (luma) data to a collocated luma block; means for calculating filter coefficients to be used to filter the current block from the reference block, the neighboring reference chroma data, and the neighboring reference luma data; and means for filtering one or more samples of the current block using the filter coefficients.

Clause 12: A method of decoding video data, the method comprising: constructing a merge candidate list for a current block of video data, including adding a first merge candidate that was predicted using a first convolutional cross component model (CCCM) to the merge candidate list and adding a second merge candidate that was predicted using a second CCCM to the merge candidate list, the first CCCM being different than the second CCCM; decoding a merge index value for the current block of video data, the merge index value indicating the first merge candidate; in response to the merge index value indicating the first merge candidate, forming a prediction block for the current block using the first CCCM; and decoding the current block using the prediction block.

Clause 13: The method of clause 12, further comprising storing parameters for the first CCCM associated with the first merge candidate.

Clause 14: The method of clause 13, wherein forming the prediction block using the first CCCM comprises forming the prediction block using the parameters for the first CCCM.

Clause 15: The method of clause 12, wherein the first CCCM comprises one of cross-component linear model (CCLM), single model CCCM, multi-model CCCM, gradient and location based CCCM (GL-CCCM), block vector guided CCCM (BVG-CCCM), or enhanced BVG-CCCM (EBVG-CCCM).

Clause 16: The method of clause 15, wherein the current block comprises a current block of chrominance (chroma) data, and wherein when the first CCCM comprises EBVG-CCCM, forming the prediction block comprises: determining a block vector referring to a reference block, neighboring reference chroma data to the current block, and neighboring reference luminance (luma) data to a collocated luma block; calculating filter coefficients to be used to filter the current block from the reference block, the neighboring reference chroma data, and the neighboring reference luma data; and filtering one or more samples of the prediction block using the filter coefficients.

Clause 17: The method of clause 16, wherein the block vector comprises a chroma block vector referring to a reference chroma block, the method further comprising determining a luma block vector referring to a reference luma block, wherein calculating the filter coefficients comprises calculating the filter coefficients using the reference luma block.

Clause 18: The method of clause 16, wherein determining the block vector comprises determining the block vector according to direct block vector (DVB) mode.

Clause 19: The method of clause 12, further comprising encoding the current block prior to decoding the current block.

Clause 20: A device for decoding video data, the device comprising: a memory configured to store video data; and a processing system comprising one or more processors implemented in circuitry, the processing system being configured to: construct a merge candidate list for a current block of video data, wherein the processing system is configured to add a first merge candidate that was predicted using a first convolutional cross component model (CCCM) to the merge candidate list and add a second merge candidate that was predicted using a second CCCM to the merge candidate list, the first CCCM being different than the second CCCM; decode a merge index value for the current block of video data, the merge index value indicating the first merge candidate; in response to the merge index value indicating the first merge candidate, form a prediction block for the current block using the first CCCM; and decode the current block using the prediction block.

Clause 21: The device of clause 20, wherein the processing system is further configured to store parameters for the first CCCM associated with the first merge candidate.

Clause 22: The device of clause 21, wherein to form the prediction block using the first CCCM, the processing system is configured to form the prediction block using the parameters for the first CCCM.

Clause 23: The device of clause 20, wherein the first CCCM comprises one of cross-component linear model (CCLM), single model CCCM, multi-model CCCM, gradient and location based CCCM (GL-CCCM), block vector guided CCCM (BVG-CCCM), or enhanced BVG-CCCM (EBVG-CCCM).

Clause 24: The method of clause 15, wherein the current block comprises a current block of chrominance (chroma) data, and wherein when the first CCCM comprises EBVG-CCCM, to form the prediction block, the processing system is configured to: determine a block vector referring to a reference block, neighboring reference chroma data to the current block, and neighboring reference luminance (luma) data to a collocated luma block; calculate filter coefficients to be used to filter the current block from the reference block, the neighboring reference chroma data, and the neighboring reference luma data; and filter one or more samples of the prediction block using the filter coefficients.

Clause 25: The device of clause 24, wherein the block vector comprises a chroma block vector referring to a reference chroma block, and wherein the processing system is further configured to determine a luma block vector referring to a reference luma block, wherein to calculate the filter coefficients, the processing system is configured to calculate the filter coefficients using the reference luma block.

Clause 26: The device of clause 24, wherein to determine the block vector, the processing system is configured to determine the block vector according to direct block vector (DVB) mode.

Clause 27: The device of clause 20, wherein the processing system is further configured to encode the current block prior to decoding the current block.

Clause 28: A device for decoding video data, the device comprising: means for constructing a merge candidate list for a current block of video data, including means for adding a first merge candidate that was predicted using a first convolutional cross component model (CCCM) to the merge candidate list and means for adding a second merge candidate that was predicted using a second CCCM to the merge candidate list, the first CCCM being different than the second CCCM; means for decoding a merge index value for the current block of video data, the merge index value indicating the first merge candidate; means for forming a prediction block for the current block using the first CCCM in response to the merge index value indicating the first merge candidate; and means for decoding the current block using the prediction block.

Clause 29: The device of clause 28, further comprising means for storing parameters for the first CCCM associated with the first merge candidate.

Clause 30: The device of clause 29, wherein the means for forming the prediction block using the first CCCM comprises means for forming the prediction block using the parameters for the first CCCM.

Clause 31: The device of clause 28, wherein the first CCCM comprises one of cross-component linear model (CCLM), single model CCCM, multi-model CCCM, gradient and location based CCCM (GL-CCCM), block vector guided CCCM (BVG-CCCM), or enhanced BVG-CCCM (EBVG-CCCM).

Clause 32: A method of decoding video data, the method comprising: constructing a merge candidate list for a current block of video data, including adding a first merge candidate that was predicted using a first convolutional cross component model (CCCM) to the merge candidate list and adding a second merge candidate that was predicted using a second CCCM to the merge candidate list, the first CCCM being different than the second CCCM; decoding a merge index value for the current block of video data, the merge index value indicating the first merge candidate; in response to the merge index value indicating the first merge candidate, forming a prediction block for the current block using the first CCCM; and decoding the current block using the prediction block.

Clause 33: The method of clause 32, further comprising storing parameters for the first CCCM associated with the first merge candidate.

Clause 34: The method of clause 33, wherein forming the prediction block using the first CCCM comprises forming the prediction block using the parameters for the first CCCM.

Clause 35: The method of any of clauses 32-34, wherein the first CCCM comprises one of cross-component linear model (CCLM), single model CCCM, multi-model CCCM, gradient and location based CCCM (GL-CCCM), block vector guided CCCM (BVG-CCCM), or enhanced BVG-CCCM (EBVG-CCCM).

Clause 36: The method of clause 35, wherein the current block comprises a current block of chrominance (chroma) data, and wherein when the first CCCM comprises EBVG-CCCM, forming the prediction block comprises: determining a block vector referring to a reference block, neighboring reference chroma data to the current block, and neighboring reference luminance (luma) data to a collocated luma block; calculating filter coefficients to be used to filter the current block from the reference block, the neighboring reference chroma data, and the neighboring reference luma data; and filtering one or more samples of the prediction block using the filter coefficients.

Clause 37: The method of clause 36, wherein the block vector comprises a chroma block vector referring to a reference chroma block, the method further comprising determining a luma block vector referring to a reference luma block, wherein calculating the filter coefficients comprises calculating the filter coefficients using the reference luma block.

Clause 38: The method of any of clauses 36 and 37, wherein determining the block vector comprises determining the block vector according to direct block vector (DVB) mode.

Clause 39: The method of any of clauses 32-38, further comprising encoding the current block prior to decoding the current block.

Clause 40: A device for decoding video data, the device comprising: a memory configured to store video data; and a processing system comprising one or more processors implemented in circuitry, the processing system being configured to: construct a merge candidate list for a current block of video data, wherein the processing system is configured to add a first merge candidate that was predicted using a first convolutional cross component model (CCCM) to the merge candidate list and add a second merge candidate that was predicted using a second CCCM to the merge candidate list, the first CCCM being different than the second CCCM; decode a merge index value for the current block of video data, the merge index value indicating the first merge candidate; in response to the merge index value indicating the first merge candidate, form a prediction block for the current block using the first CCCM; and decode the current block using the prediction block.

Clause 41: The device of clause 40, wherein the processing system is further configured to store parameters for the first CCCM associated with the first merge candidate.

Clause 42: The device of clause 41, wherein to form the prediction block using the first CCCM, the processing system is configured to form the prediction block using the parameters for the first CCCM.

Clause 43: The device of any of clauses 40-42, wherein the first CCCM comprises one of cross-component linear model (CCLM), single model CCCM, multi-model CCCM, gradient and location based CCCM (GL-CCCM), block vector guided CCCM (BVG-CCCM), or enhanced BVG-CCCM (EBVG-CCCM).

Clause 44: The method of clause 43, wherein the current block comprises a current block of chrominance (chroma) data, and wherein when the first CCCM comprises EBVG-CCCM, to form the prediction block, the processing system is configured to: determine a block vector referring to a reference block, neighboring reference chroma data to the current block, and neighboring reference luminance (luma) data to a collocated luma block; calculate filter coefficients to be used to filter the current block from the reference block, the neighboring reference chroma data, and the neighboring reference luma data; and filter one or more samples of the prediction block using the filter coefficients.

Clause 45: The device of clause 44, wherein the block vector comprises a chroma block vector referring to a reference chroma block, and wherein the processing system is further configured to determine a luma block vector referring to a reference luma block, wherein to calculate the filter coefficients, the processing system is configured to calculate the filter coefficients using the reference luma block.

Clause 46: The device of any of clauses 44 and 45, wherein to determine the block vector, the processing system is configured to determine the block vector according to direct block vector (DVB) mode.

Clause 47: The device of any of clauses 40-46, wherein the processing system is further configured to encode the current block prior to decoding the current block.

Clause 48: A device for decoding video data, the device comprising: means for constructing a merge candidate list for a current block of video data, including means for adding a first merge candidate that was predicted using a first convolutional cross component model (CCCM) to the merge candidate list and means for adding a second merge candidate that was predicted using a second CCCM to the merge candidate list, the first CCCM being different than the second CCCM; means for decoding a merge index value for the current block of video data, the merge index value indicating the first merge candidate; means for forming a prediction block for the current block using the first CCCM in response to the merge index value indicating the first merge candidate; and means for decoding the current block using the prediction block.

Clause 49: The device of clause 48, further comprising means for storing parameters for the first CCCM associated with the first merge candidate.

Clause 50: The device of clause 49, wherein the means for forming the prediction block using the first CCCM comprises means for forming the prediction block using the parameters for the first CCCM.

Clause 51: The device of any of clauses 48-50, wherein the first CCCM comprises one of cross-component linear model (CCLM), single model CCCM, multi-model CCCM, gradient and location based CCCM (GL-CCCM), block vector guided CCCM (BVG-CCCM), or enhanced BVG-CCCM (EBVG-CCCM).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
constructing a merge candidate list for a current block of video data, including adding a first merge candidate that was predicted using a first convolutional cross component model (CCCM) to the merge candidate list and adding a second merge candidate that was predicted using a second CCCM to the merge candidate list, the first CCCM being different than the second CCCM;
decoding a merge index value for the current block of video data, the merge index value indicating the first merge candidate;
in response to the merge index value indicating the first merge candidate, forming a prediction block for the current block using the first CCCM; and
decoding the current block using the prediction block.

2. The method of claim 1, further comprising storing parameters for the first CCCM associated with the first merge candidate.

3. The method of claim 2, wherein forming the prediction block using the first CCCM comprises forming the prediction block using the parameters for the first CCCM.

4. The method of claim 1, wherein the first CCCM comprises one of cross-component linear model (CCLM), single model CCCM, multi-model CCCM, gradient and location based CCCM (GL-CCCM), block vector guided CCCM (BVG-CCCM), or enhanced BVG-CCCM (EBVG-CCCM).

5. The method of claim 4, wherein the current block comprises a current block of chrominance (chroma) data, wherein the first CCCM comprises EBVG-CCCM, and wherein forming the prediction block comprises:
determining a block vector referring to a reference block;
determining neighboring reference chrominance (chroma) data to the current block and neighboring reference luminance (luma) data to a collocated luma block;
calculating filter coefficients to be used to filter the current block from the reference block, the neighboring reference chroma data, and the neighboring reference luma data; and
filtering one or more samples of the prediction block using the filter coefficients.

6. The method of claim 5, wherein the block vector comprises a chroma block vector referring to a reference chroma block, the method further comprising determining a luma block vector referring to a reference luma block, wherein calculating the filter coefficients comprises calculating the filter coefficients using the reference luma block.

7. The method of claim 5, wherein determining the block vector comprises determining the block vector according to direct block vector (DVB) mode.

8. The method of claim 1, further comprising encoding the current block prior to decoding the current block.

9. A device for decoding video data, the device comprising:
a memory configured to store video data; and
a processing system comprising one or more processors implemented in circuitry, the processing system being configured to:
construct a merge candidate list for a current block of video data, wherein the processing system is configured to add a first merge candidate that was predicted using a first convolutional cross component model (CCCM) to the merge candidate list and add a second merge candidate that was predicted using a second CCCM to the merge candidate list, the first CCCM being different than the second CCCM;
decode a merge index value for the current block of video data, the merge index value indicating the first merge candidate;
in response to the merge index value indicating the first merge candidate, form a prediction block for the current block using the first CCCM; and
decode the current block using the prediction block.

10. The device of claim 9, wherein the processing system is further configured to store parameters for the first CCCM associated with the first merge candidate.

11. The device of claim 10, wherein to form the prediction block using the first CCCM, the processing system is configured to form the prediction block using the parameters for the first CCCM.

12. The device of claim 9, wherein the first CCCM comprises one of cross-component linear model (CCLM), single model CCCM, multi-model CCCM, gradient and location based CCCM (GL-CCCM), block vector guided CCCM (BVG-CCCM), or enhanced BVG-CCCM (EBVG-CCCM).

13. The device of claim 12, wherein the current block comprises a current block of chrominance (chroma) data, and wherein when the first CCCM comprises EBVG-CCCM, to form the prediction block, the processing system is configured to:
determine a block vector referring to a reference block, neighboring reference chroma data to the current block, and neighboring reference luminance (luma) data to a collocated luma block;
calculate filter coefficients to be used to filter the current block from the reference block, the neighboring reference chroma data, and the neighboring reference luma data; and
filter one or more samples of the prediction block using the filter coefficients.

14. The device of claim 13, wherein the block vector comprises a chroma block vector referring to a reference chroma block, and wherein the processing system is further configured to determine a luma block vector referring to a reference luma block, wherein to calculate the filter coefficients, the processing system is configured to calculate the filter coefficients using the reference luma block.

15. The device of claim 13, wherein to determine the block vector, the processing system is configured to determine the block vector according to direct block vector (DVB) mode.

16. The device of claim 9, wherein the processing system is further configured to encode the current block prior to decoding the current block.

17. A device for decoding video data, the device comprising:
means for constructing a merge candidate list for a current block of video data, including means for adding a first merge candidate that was predicted using a first convolutional cross component model (CCCM) to the merge candidate list and means for adding a second merge candidate that was predicted using a second CCCM to the merge candidate list, the first CCCM being different than the second CCCM;
means for decoding a merge index value for the current block of video data, the merge index value indicating the first merge candidate;
means for forming a prediction block for the current block using the first CCCM in response to the merge index value indicating the first merge candidate; and
means for decoding the current block using the prediction block.

18. The device of claim 17, further comprising means for storing parameters for the first CCCM associated with the first merge candidate.

19. The device of claim 18, wherein the means for forming the prediction block using the first CCCM comprises means for forming the prediction block using the parameters for the first CCCM.

20. The device of claim 17, wherein the first CCCM comprises one of cross-component linear model (CCLM), single model CCCM, multi-model CCCM, gradient and location based CCCM (GL-CCCM), block vector guided CCCM (BVG-CCCM), or enhanced BVG-CCCM (EBVG-CCCM).
